(19) United States
(12) Patent Application Publication
(10) Pub. No.: US 2010/0137038 A1
(43) Pub. Date: Jun. 3, 2010

(54) Interchangeable Docking Cradle

(75) Inventors: Brian W. Scholz, Santa Cruz, CA (US); James E. Blum, San Jose, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: PLANTRONICS, INC., Santa Cruz, CA (US)

(21) Appl. No.: 12/326,049

(22) Filed: Dec. 1, 2008

(51) Int. Cl. H04B 1/38

(52) U.S. Cl. 455/573

(57) ABSTRACT

In one embodiment, a headset charging base includes a power source interface, a docking cradle interface configured to interface with one of a plurality of interchangeable docking cradles having different form factors for receiving different headsets, and a housing enclosing an electrical connection between the power source interface and the docking cradle interface. A headset charging system including such a charging base, a method of use, and a method of packaging a headset system are also disclosed.

### BACKGROUND

1. Field of the Invention

This invention generally relates to headsets and, more particularly, to a headset charging system, apparatus, and method.

2. Description of Related Art

Communication headsets are used in numerous applications and are particularly effective for telephone operators, radio operators, aircraft personnel, and for any user for whom it is desirable to have hands free operation of communication systems. Accordingly, a wide variety of conventional headsets are available with different shapes and designs, including over-the-head type headsets, over-the-ear type headsets, and in-the-ear type headsets. Furthermore, headsets may be adapted for use with a variety of devices, included corded and cordless telephones, soft phones, cellular phones, PDAs, and the like.

Wireless headsets and other portable communications devices are often battery powered such that a user can use the wireless headset or other such device without being directly connected to larger power sources such as an AC outlet or automobile battery. This allows wireless headset users flexibility and convenience to move about without being tied to a power cord. Wireless headset batteries are generally rechargeable so that the batteries can be recharged and need not be discarded after single use.

In the prior art, devices employing rechargeable batteries typically have charging contacts so that charging current power can be supplied to recharge the batteries without removing the batteries from the device. In one typical setup, the portable device is inserted into a base charger which has contacts that correspond to and couple with the contacts on the portable device. For example, such a setup is used with remote handset phones used in the home. The base charger is connected to a power source, and supplies charging current through the coupled contacts to recharge the batteries located within the device.

Wireless headsets may be also be charged using a docking station such as a desktop charger, or other combined storage and charging mechanism to facilitate the charging of the wireless headset. However, a single charging base has not been available to charge a variety of headsets having different form factors and thus different chargers have been generally required to charge different headsets. Furthermore, since each charging base has been specific to a headset, packaging and identification of a headset product and its charger have been constrained and inflexible.

Therefore, there is a need in the art for a headset charging system, apparatus, and method that is simple to use, cost-effective, provides flexibility, and/or provides for efficiencies in packaging.

### SUMMARY

In accordance with the present invention, a headset charging base, a headset charging system, and a method of charging various headsets are disclosed.

In one embodiment of the invention, a headset charging base includes a power source interface, a docking cradle interface configured to interface with one of a plurality of interchangeable docking cradles having different form factors for receiving different headsets, and a housing enclosing an electrical connection between the power source interface and the docking cradle interface.

In another embodiment of the invention, a headset charging system includes a headset charging base as described above, a power source operably coupled to the power source interface, and an interchangeable docking cradle operably coupled to the docking cradle interface.

In yet another embodiment, a method of charging headsets includes providing a headset charging base as described above, coupling a power source to the power source interface, coupling a first docking cradle to the docking cradle interface, docking a first headset in the first docking cradle to charge the first headset, interchanging the first docking cradle with a second docking cradle, and docking a second headset in the second docking cradle to charge the second headset.

In yet another embodiment, a method of packaging headsets comprises providing a plurality of common charging bases from a first location, with each charging base including a power source interface, a docking cradle interface configured to interface with one of a plurality of interchangeable docking cradles having different form factors, and a housing enclosing an electrical connection between the power source interface and the docking cradle interface. The method further includes providing a plurality of docking cradles with different form factors for receiving different headsets, and packaging a common charging base, a specified docking cradle, and a corresponding headset at a second location different from the first location.

Advantageously, the present invention provides a single charging base that can be used to charge various headsets having various form factors in a cost-effective and flexible manner. Furthermore, the present invention allows for cost efficiencies in shipping and packaging of a headset system.

These and other features and advantages of the present invention will be more readily apparent from the detailed description of the embodiments set forth below taken in conjunction with the accompanying drawings.

### BRIEF DESCRIPTION OF THE DRAWINGS

FIG. 1 illustrates a headset charging system in accordance with an embodiment of the present invention.

FIG. 2 illustrates a sequence and method for using different docking cradles with a headset charging base in accordance with an embodiment of the present invention.

FIGS. 3A-3C illustrate perspective views of components of a headset charging system including a first docking cradle and a corresponding first headset in accordance with an embodiment of the present invention.

FIGS. 4A-4B illustrate perspective views of components of a headset charging system including a second docking cradle and a corresponding second headset in accordance with another embodiment of the present invention.

FIGS. 5A-5B illustrate perspective views of components of a headset charging system including a third docking cradle and a corresponding third headset in accordance with another embodiment of the present invention.

FIG. 6 is a flowchart of a method for charging different headsets in accordance with an embodiment of the present invention.

FIG. 7 is a flowchart of a method for efficient packaging of a headset charging system in accordance with an embodiment of the present invention.

Embodiments of the present invention and their advantages are best understood by referring to the detailed description that follows. It should be appreciated that like reference numerals in different figures indicate similar or identical items. It should also be appreciated that the figures may not be necessarily drawn to scale.

### DETAILED DESCRIPTION

In accordance with the present invention, systems, apparatus, and methods are disclosed for utilizing a single charging base with interchangeable docking cradles to charge different headsets, allowing for advantageous flexibility in use and efficiencies in packaging.

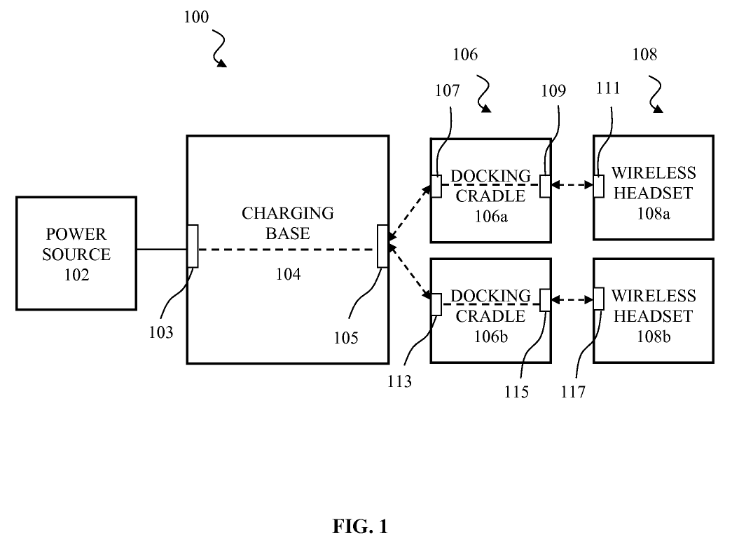

Referring now to FIG. 1, a headset charging system 100 is illustrated in accordance with an embodiment of the present invention. Headset charging system 100 includes a charging base 104 operably couplable to a power source 102 and an interchangeable docking cradle 106 (such as one of docking cradles 106a or 106b which are each specific to a headset). A wireless headset 108 (such as one of wireless headsets 108a or 108b) corresponds to a docking cradle 106 (such as docking cradle 106a or 106b, respectively), and may electrically communicate with an electrical contact of the docking cradle via an electrical contact of the headset. In one example, electrical contacts 109 and 115 of the docking cradles are operably couplable to electrical contacts 111 and 117 of the headsets, respectively.

Charging base 104 includes a power source interface 103 that is operably couplable to power source 102, and a docking cradle interface 105 that is operably couplable to an interchangeable docking cradle, such as docking cradles 106a or 106b. Docking cradle interface 105 may include an electrical wire and a connector at a free end of the wire that can operably mate with an electrical contact of the docking cradle, such as electrical contacts 107 or 113.

It is noted that various electrical contact means and methods may be used between the components of the headset charging system (e.g., between the charging base and the docking cradle or between the docking cradle and the headset), such as contact strips, pogo pins and apertures, plugs and sockets, and so on, as more fully disclosed in commonly assigned U.S. Pat. No. 7,075,270, which is incorporated by reference herein in its entirety for all purposes.

In one example, power source interface 103 is an electrical connector operably couplable to one or more of various power sources 102, such as an alternating current adapter, a direct current adapter, a battery (e.g., alkaline, NiCad, or Lithium batteries in AA or AAA form factors, or various other suitable types of batteries), or a solar cell. Power source interface 103 may also include connectors for connection to a cord that is connected to a main AC power supply of the type utilized with a common wall outlet, and/or an AC/DC power converter which converts an external power supply to a standard DC voltage which is usable by the charging base for charging a battery therein.

Power source interface 103 is electrically coupled to docking cradle interface 105, for example by a wire or other electrical connection enclosed within a housing of charging base 104. The housing is preferably made of a lightweight organic polymer, but can be comprised of any suitable material. An underside portion of the housing provides support and a non-scratching material for the bottom of the charging base, in one example. Thus, power from power source 102 is transferred through power source interface 103, docking cradle interface 105, contacts in the docking cradle, and mating contacts in a docked headset to charge the headset.

Charging base 104 may further include components typical of battery charging devices, such as circuitry or processors for controlling the supply of charging current to an inserted device based on the battery status, and indicators for identifying the charging status of the headset battery. Charging circuitry and associated components may be mounted on a printed circuit board (PCB) disposed within the charging base. The charging system 100 may also include various features such as a vibrate ring feature, a caller ID display, and/or a visual ring indicator. Each feature may be directly integrated in the headset charging base 104, another component of the charging system, and/or on the headset itself but is accessible and/or visible while the headset is stored on the charging base. In other embodiments, charging base 104 may include interfaces for a RJ-11 connector or a 2-3.5 mm plug, which may be used to operably connect the charging base and an associated headset to an audio source, such as a telephone handset, cellular telephone, or a computer.

The docking cradle is couplable to a front wall of the charging base housing, in one example, and includes an electrical contact 107 or 113 for electrical communication with charging base 104, an electrical contact 109 or 115 for electrical communication with a headset, and a cavity or well for physically receiving a headset. In one example, each of the docking cradle electrical contacts 107 or 113 can also include an electrical wire and a connector at a free end of the wire that is connectable with the connector of the docking cradle interface 105. Various structures may be utilized for electrical contacts 109 and 115 as noted above, such as contact strips, pogo pins and apertures, plugs and sockets, and so on, as more fully disclosed in commonly assigned U.S. Pat. No. 7,075,270, which has been previously incorporated by reference herein in its entirety for all purposes.

The cradle well properly guides the headset such that conductive contacts 111 or 117 disposed on the headset are properly aligned with the electrical contacts 109 or 115 in the docking cradle. Thus, the docking cradle serves as an electrical and mechanical interface between the charging base and the headset, and the headset is able to be charged by charging base 104 when docked within a respective docking cradle. In one example, the docking cradle may be inclined at approximately 5 to 10 degrees from vertical allowing for convenient insertion of the headset, although other angles or no angle may be utilized.

It is noted that various docking cradles may be configured to receive various types, shapes and/or configurations of headsets and that headsets shown and described below are merely examples suitable for use with the headset charging system, apparatus, and methods of the present invention.

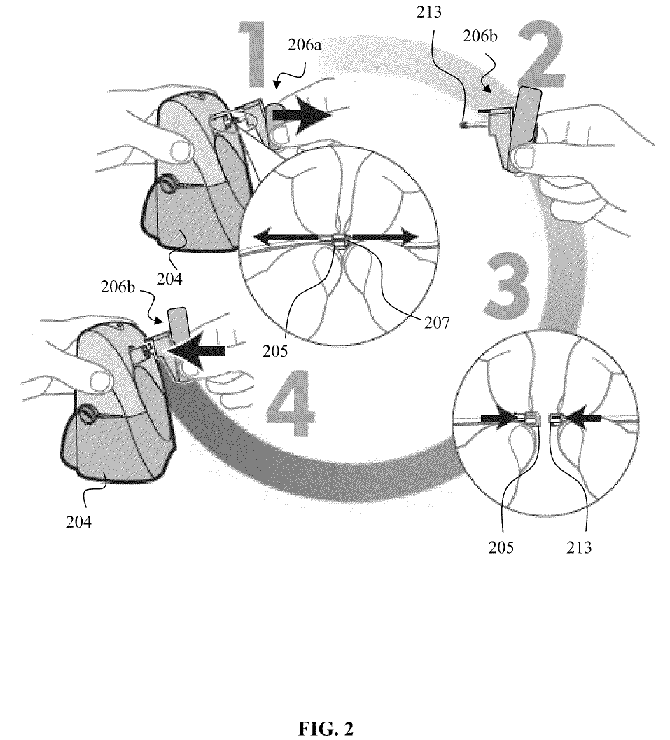

Referring now to FIG. 2, a sequence and a method for using different docking cradles 206a and 206b with a headset charging base 204 are illustrated in accordance with an embodiment of the present invention. At a step 1, an electrical contact 207 (e.g., including a charging wire and a connector) of docking cradle 206a is disengaged from a docking cradle interface 205 (e.g., including a charging wire and a connector) of charging base 204. In one example, the charging wires have mating connectors at their free ends so that the wires are electrically couplable when the connectors are placed together or the wires are electrically separable when the connecting ends are pulled apart. At a step 2, docking cradle 206a is replaced with a docking cradle 206b having an electrical contact 213 (e.g., including a charging wire and a connector), which is engaged with docking cradle interface 205 of charging base 204 at a step 3. At a step 4, docking cradle 206b is mechanically mounted onto charging base 204 by receiving a protrusion of charging base 204 in a recess of the docking cradle 208. In other embodiments, the docking cradle may be mounted onto the charging base by placing a protrusion of the docking cradle into a recess of the charging base. Accordingly, docking cradle 206b is mechanically and electrically coupled to charging base 204 and ready to receive a corresponding headset. Docking cradle 206b has a different form factor from docking cradle 206a and thus can receive a headset having a form factor different than the headset that corresponds to the docking cradle 206a.

Different docking cradles and their respective headsets that are mountable on the docking cradles will now be illustrated and described in accordance with embodiments of the present invention.

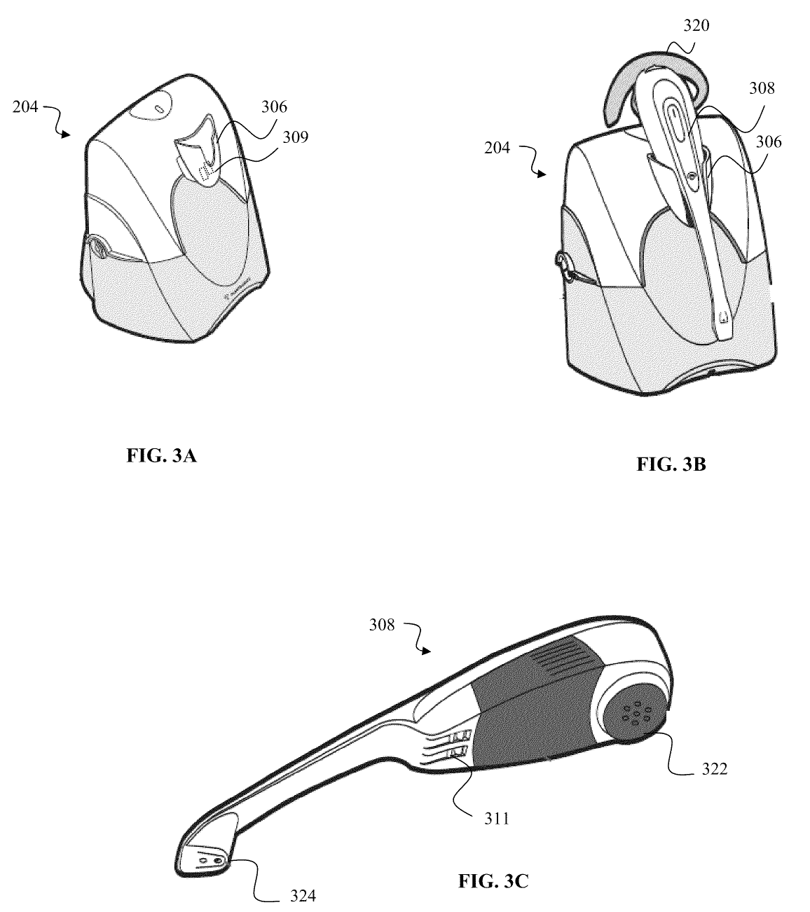

FIGS. 3A-3C illustrate perspective views of the components of a headset charging system including charging base 204, a first docking cradle 306 having contact strips 309, and a corresponding first headset 308 having contact strips 311 couplable with contact strips 309, in accordance with an embodiment of the present invention. Docking cradle 306 is operably coupled to charging base 204, in one example, being electrically and mechanically coupled in a similar manner as described above with respect to FIG. 2.

When headset 308 is mounted on docking cradle 306, contact strips 309 operably mate with contact strips 311 of headset 308, thereby electrically coupling headset 308 to charging base 204. In a further example, docking cradle 306 includes a cavity or well portion that mechanically receives a portion of headset 308 when the headset is docked. In this embodiment, headset 308 is an over-the-ear type of headset and includes an earloop 320, a microphone 324 to enable two-way voice communication by the user, and a speaker housing 322 that houses an internal speaker, which in one example is an electro-acoustic speaker that receives audio signals from an audio signal source and may comprise a known type of electromagnetic, piezoelectric, or electrostatic type of driving element, or a combination thereof, or even some other form of driving element, for generating sound waves from the output face of the speaker. It is noted however that various applicable speakers may be used. Headset 308 is a wireless headset that operates following Bluetooth, Wifi, or other wireless protocol. The illustrative headset shown and described is also a monaural headset having a single audio receiver for placement near one ear and an earloop configured to fit around the ear to secure the receiver in place. However, it is to be understood that various docking cradles may be configured to receive various other types, shapes and/or configurations of headsets and that the monaural headset shown and the other headsets shown and described below are merely examples suitable for use with the headset charging system, apparatus, and methods of the present invention.

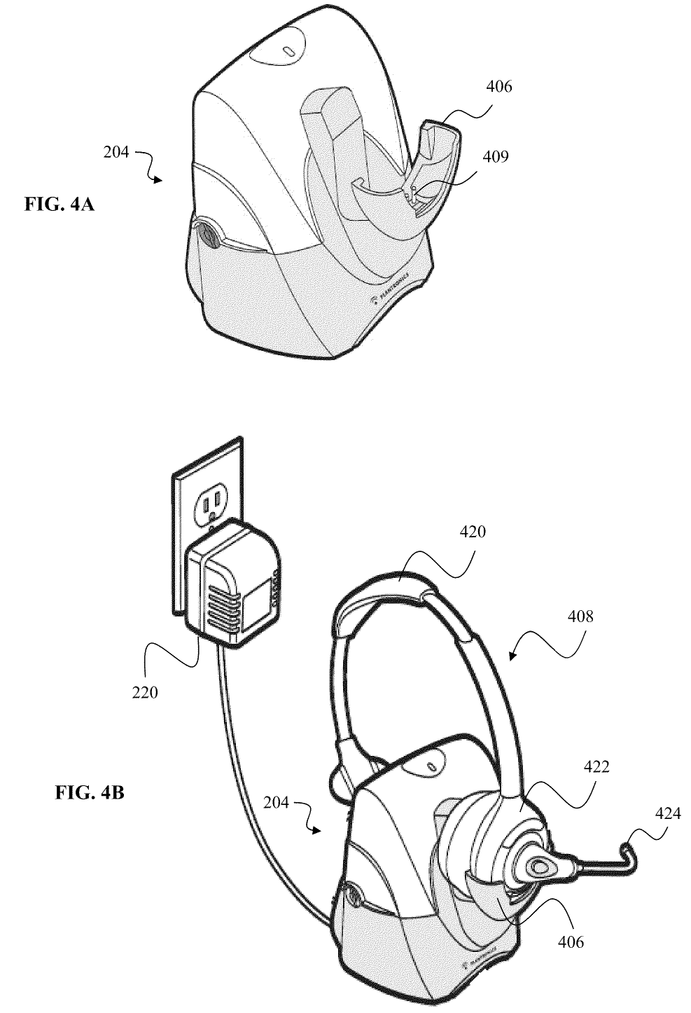

FIGS. 4A-4B illustrate perspective views of the components of another headset charging system including charging base 204, a second docking cradle 406 having pogo pins 409, and a corresponding second headset 408 having contact apertures (not shown) that are couplable with pogo pins 409, in accordance with an embodiment of the present invention. Docking cradle 406 is operably coupled to charging base 204, in one example, being electrically and mechanically coupled in a similar manner as described above with respect to FIG. 2. When headset 408 is mounted on docking cradle 406, pogo pins 409 operably mate with contact apertures (not shown) in the headset, thereby electrically coupling headset 408 to charging base 204 and therefore the power source. Alternatively, pogo pins of a headset may mate with apertures in the docking cradle. In a further example, docking cradle 406 includes a cavity or well portion that mechanically receives a portion of headset 408 when the headset is docked. In this embodiment, headset 408 is an over-the-head type of headset and includes a band 420, a microphone tube 424, and a speaker housing 422. An AC adapter 220 coupled to charging base 204 and plugged into an electrical outlet is also illustrated.

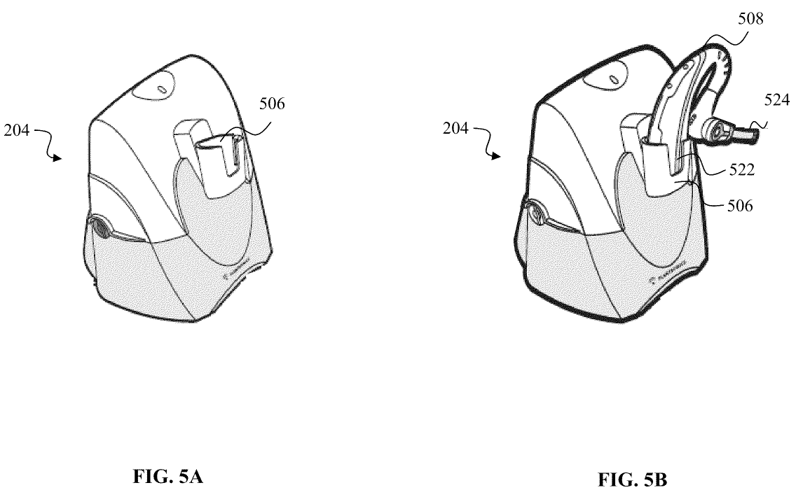

FIGS. 5A-5B illustrate perspective views of the components of another headset charging system including charging base 204, a third docking cradle 506, and a corresponding third headset 508, in accordance with an embodiment of the present invention. Docking cradle 506 is operably coupled to charging base 204, in one example, being electrically and mechanically coupled in a similar manner as described above with respect to FIG. 2. Headset 508 is mounted on and electrically coupled to docking cradle 506 via contact strips or contact recesses or pogo pins as described above, thereby electrically coupling headset 508 to charging base 204 and therefore the power source. In this embodiment, headset 508 is an over-the-ear type of headset and includes a microphone tube 524 and a speaker housing 522.

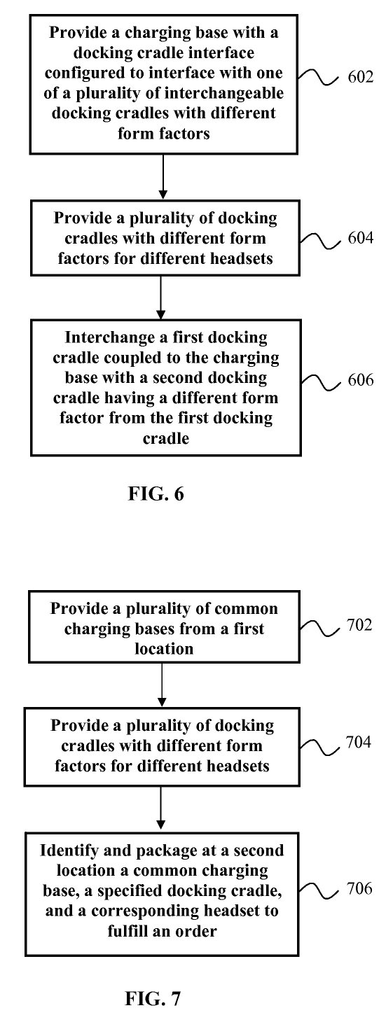

Referring now to FIGS. 6 and 7, methods of using a charging base with interchangeable docking cradles and of using such a charging base for efficient packaging will be described in accordance with embodiments of the present invention.

FIG. 6 is a flowchart of a method for charging different headsets in accordance with an embodiment of the present invention. At step 602, a charging base similar to those described above is provided. The charging base includes a docking cradle interface configured to interface with one of a plurality of interchangeable docking cradles with different form factors, as provided for at step 604. At step 606, a first docking cradle which is coupled to the charging base is interchanged with a second docking cradle having a different form factor from the first docking cradle. A different headset having a different form factor from a first headset can then be charged with the same charging base.

FIG. 7 is a flowchart of a method for efficient packaging of a headset system including a wireless headset and charging base in accordance with an embodiment of the present invention. The present invention allows for postponement of system packaging such that a greater number of common charging bases may be purchased at once at a first location and shipped by bulk to a second location where the charging base, interchangeable docking cradle, and corresponding headset can be identified and packaged to fulfill customer orders at a subsequent time from the purchase of the common charging base. In other words, systems may be packaged to order from basic subassemblies, which may lead to efficiencies in shipping, labor, cost, and/or time. For example, at a step 702, a plurality of common charging bases are provided from a first location, such as in Asia. At step 704, a plurality of docking cradles with different form factors for different headsets are also provided from the same or another location. Finally at step 706, a common charging base is used as a building block in a package with a specified docking cradle and a corresponding headset, which are identified and packaged at a second location, such as in North America, to fulfill a specified customer order.

Advantageously, the present invention provides for a charging apparatus and system that is cost-effective and flexible in use. Furthermore, such postponement of system packaging until made specific to order allows for efficiencies in shipping, labor, cost, and/or time.

The above-described embodiments of the present invention are merely meant to be illustrative and not limiting. It will thus be obvious to those skilled in the art that various changes and modifications may be made without departing from this invention in its broader aspects. For example, the docking cradles may be mechanically and electrically coupled to the charging base by various means and methods besides electrical wire connectors, including but not limited to contacts strips and pogo pins/recesses, and the docking cradle interface may include more than one means of electrical connection to a docked headset. Furthermore, the headset may be electrically coupled to the docking cradle by various means and methods besides contact strips and pogo pins/recesses. Therefore, the appended claims encompass all such changes and modifications as falling within the true spirit and scope of this invention.

We claim:

1. A headset charging base, comprising:
a power source interface;
a docking cradle interface configured to interface with one of a plurality of interchangeable docking cradles having different form factors for receiving different headsets; and
a housing enclosing an electrical connection between the power source interface and the docking cradle interface.

2. The charging base of claim 1, wherein the power source interface is operably couplable to one of an alternating current adapter, a direct current adapter, a battery, or a solar cell.

3. The charging base of claim 1, wherein the docking cradle interface includes an electrical connector that can be coupled to a mating electrical connector of a docking cradle.

4. The charging base of claim 1, wherein the docking cradle interface includes a protrusion for coupling to a recess of a docking cradle or a recess for coupling to a protrusion of a docking cradle.

5. The charging base of claim 1, wherein the different headsets includes in-the-ear type headsets, over-the-ear type headsets, or over-the-head type headsets.

6. A headset charging system, comprising:
a headset charging base including:
a power source interface;
a docking cradle interface configured to interface with one of a plurality of interchangeable docking cradles having different form factors for receiving different headsets; and
a housing enclosing an electrical connection between the power source interface and the docking cradle interface;
a power source operably coupled to the power source interface; and
an interchangeable docking cradle operably coupled to the docking cradle interface.

7. The system of claim 6, wherein the docking cradle interface includes an electrical connector coupled to a mating electrical connector of the docking cradle.

8. The system of claim 6, wherein the docking cradle interface includes a protrusion for coupling to a recess of a docking cradle or a recess for coupling to a protrusion of a docking cradle.

9. The system of claim 6, wherein the power source includes one of an alternating current adapter, a direct current adapter, a battery, or a solar cell.

10. The system of claim 6, wherein the docking cradle includes pogo pins that can be mated with electrical connection apertures of a headset.

11. The system of claim 6, wherein the docking cradle includes planar contact strips that can be coupled with planar contact strips of a headset.

12. The system of claim 6, wherein the docking cradle includes a well for receiving a headset, and a recess for receiving a protrusion of the charging base.

13. The system of claim 6, wherein the different headsets includes in-the-ear type headsets, over-the-ear type headsets, or over-the-head type headsets.

14. A method of charging headsets, the method comprising:
providing a headset charging base including:
a power source interface;
a docking cradle interface configured to interface with one of a plurality of interchangeable docking cradles having different form factors for receiving different headsets; and
a housing enclosing an electrical connection between the power source interface and the docking cradle interface;
coupling a power source to the power source interface;
coupling a first docking cradle to the docking cradle interface;
docking a first headset in the first docking cradle to charge the first headset;
interchanging the first docking cradle with a second docking cradle; and
docking a second headset in the second docking cradle to charge the second headset.

15. The method of claim 14, wherein the second docking cradle has a different form factor from the first docking cradle.

16. The method of claim 14, wherein coupling the first docking cradle to the docking cradle interface includes coupling an electrical connector of the docking cradle interface to a mating electrical connector of the first docking cradle.

17. The method of claim 14, wherein docking the first headset in the first docking cradle includes coupling pogo pins of the docking cradle to mating electrical connection apertures of the first headset.

18. The method of claim 14, wherein docking the first headset in the first docking cradle includes coupling planar contact strips of the docking cradle to mating planar contact strips of the first headset.

19. The method of claim 14, wherein coupling the power source to the power source interface includes coupling one of an alternating current adapter, a direct current adapter, a battery, or a solar cell.

20. The method of claim 14, wherein the first and second headsets includes in-the-ear type headsets, over-the-ear type headsets, or over-the-head type headsets.

21. A method of packaging headset systems, the method comprising:
providing a plurality of common charging bases from a first location, each charging base including:
a power source interface;
a docking cradle interface configured to interface with one of a plurality of interchangeable docking cradles having different form factors; and
a housing enclosing an electrical connection between the power source interface and the docking cradle interface;
providing a plurality of docking cradles with different form factors for receiving different headsets; and
packaging a common charging base, a specified docking cradle, and a corresponding headset at a second location different from the first location.

22. The method of claim 21, wherein the corresponding headset is selected from the group consisting of in-the-ear type headsets, over-the-ear type headsets, and over-the-head type headsets.
